(19) United States
(12) Patent Application Publication
(10) Pub. No.: US 2014/0052499 A1
(43) Pub. Date: Feb. 20, 2014

(54) Telenostics performance logic

(71) Applicants: Ronald E. Wagner, Fleming Island, FL (US); Robert Charlton, Fredericksburg, VA (US); Greg Thompson, San Diego, CA (US); Robert Ufford, Roswell, GA (US)

(72) Inventors: Ronald E. Wagner, Fleming Island, FL (US); Robert Charlton, Fredericksburg, VA (US); Greg Thompson, San Diego, CA (US); Robert Ufford, Roswell, GA (US)

(21) Appl. No.: 12/800,908

(22) Filed: May 25, 2010

Related U.S. Application Data
(63) Continuation of application No. 12/660,209, filed on Feb. 23, 2010, now abandoned.
(60) Provisional application No. 61/154,631, filed on Feb. 23, 2009.

(51) Int. Cl. G06Q 10/00; G06F 7/00; G06Q 90/00

(52) U.S. Cl. 705/7.36; 705/500; 705/7.37; 701/29.3

(57) ABSTRACT

In a method for managing a vehicle fleet using operational and maintenance data, wherein the improvement comprises the steps of also using financial, environmental, and industry data.

### RELATED APPLICATIONS

This is a continuation of co-pending patent application Ser. No. 12/660,209 filed Feb. 23, 2010 entitled Telenostics Performance Logic and claims rights under 35 USC §119(e) from U.S. Application Ser. No. 61/154,631 filed Feb. 23, 2009, the contents of which are incorporated herein by reference.

### FIELD OF THE INVENTION

The present invention relates to vehicle fleet management and more particularly to vehicle fleet management using integration and knowledge fusion incorporating financial data to provide favorable outcomes.

### BACKGROUND OF THE INVENTION

The data information age has brought myriads of specialized applications for data collection, tracking and visualization to provide specific knowledge for commercial fleet managers to help them more effectively manage their fleets. Heretofore, the market has been filled with applications and databases which focus within a single or narrow range of information domain to solve specific problems or provide specific conclusions. For example, maintenance/diagnostic applications focus on what is wrong with a vehicle, while asset tracking applications focus on where a vehicle is, both from a vehicle-centric and asset to asset perspective. There are limited applications which attempt to effectively “fuse” vehicle-centric information into user performance knowledge, fewer that allow the tailoring of this to specific fleet industry type, and less still that fuse both of these with external environmental, business intelligence, or financial information either external or internal to the user's industry. What fleet managers are lacking is a tailorable and integrated performance knowledge solution which provides the integration and information fusion from separate and potentially disparate databases/applications into a single performance portal tailored to their industry and their specific performance objectives.

A need exists, therefore, for a favorable and integrated performance knowledge solution for providing an information fusion approach to vehicle fleet management. More particularly, In U.S. patent application Ser. No. ______ (docket no. BAEP-1159) filed on even date with this application and which is incorporated herein by reference, a method which is known as the telenostics method addresses remote and mobile assets as well as fleet operations. This method enhances mission performance at a lower total ownership cost. The operational principles guide movement to the point of performance those actions that achieve mission performance. This is accomplished with enabling technologies that operate with a minimum of infrastructure. It not just about getting a current snapshot of operations.

A need, however, still exists to improve the telenostics method.

Note, Telenostic systems are described in the following U.S. patent applications, filed on even date herewith, assigned to the assignee hereof and incorporated herein by reference: Ser. No. ______ (docket number BAEP 1140) Diagnostic Connector Assembly (DCA) Interface Unit (DIU), Ser. No. ______ (docket number BAEP 1141) In Service Support Center and Method of Operation, Ser. No. ______ (docket number BAEP 1159) Telenostics, Ser. No. ______ (docket number BAEP 1160) Portable Performance. Support Device and Method for Use, and Ser. No. ______ (docket number BAEP 1162) Telenostics Certify.

### SUMMARY OF INVENTION

In a method for managing a vehicle fleet using operational and maintenance data, wherein the improvement comprises the steps of also using financial, environmental, and industry data.

According to the present invention, users are provided with the performance based solutions via the derived output of a performance logic module which is used in conjunction with the above mentioned telenostics system for optimizing the performance metrics that were most important to their fleet/industry/financial desires.

While the telenostics system provides companies with useful fleet management knowledge, there is a requirement for financial information input so that a efficient repair or replace decision can be made. Additionally, the performance logic module expands its efficacy through learned experiences.

As a result, business intelligence can be improved by providing companies with cost and financial information that is timely, adapted to provide only the relevant knowledge that most effects performance outcomes, and takes advantage of multitudes of databases and information that can be “brokered” to a company without the internal investment by their own IT or development organizations.

As the business model, the industry, or the fleet changes, the factors, metrics and knowledge which most influence desirable performance objectives change. As part of the subject invention, companies can access their performance logic module so that changes in the required level of information provides an output useful in realtime maintenance planning that ultimately increases profit by taking into account operating or total life cycle savings. This incorporates the ability to target a solution tailored toward new or modified performance needs taking into account lifecycle effects and costs as well as equipment availability.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the subject in-service maintenance system including real-time location, usage monitoring, diagnostics exceedances and sensor data transmitted to a module for data analysis and performance monitoring that is in turn coupled to a web portal interface for reporting fleet status and asset status and for receiving filtered and summarized maintenance data;

FIG. 2 is a diagrammatic illustration of the incorporation of financial information into the telenostics process; and,

FIG. 3 is a diagrammatic representation of various costs involved for a given asset, vehicle or fleet performance element that forms one of the data inputs to the performance logic module.

### DETAILED DESCRIPTION

According to the present invention, telenostics performance logic applications/modules provide a means for interfacing disparate vehicle, industry, financial and environmental-centric databases and applications through a central data grid; analyze and “fuse” the appropriate levels of knowledge from those sources; and develop specific fleet/industry/user performance conclusions and intelligence that solves the specific short term and long term performance driven outcomes that the user desires. This starts with a structured business case modeling process with the customer, which develops the desired performance-based outcomes and interfaces for the customer, unique to his business, processes, industry, fleet and financial objectives. The performance logic module then provides the integration and knowledge fusion to provide those outcomes, based on all information sources that are deemed necessary and sufficient to be collected, linked and normalized through the data grid portals. Over time, as generic and user specific performance logic modules get developed, an economy will be realized where existing modules and their associated ever increasing/improving prescribed performance recommendations can be re-used and tailorable for other applications and customers. Since the performance logic module extends the original telenostics systems a brief description of telenostics is presented.

### Telenostics

By way of backdround as to a telenostics system, in order to transform a static maintenance structure into a dynamic management environment, one collects real-time data and uses this data to adjust the original equipment manufacturer's maintenance plan to account for changes in operation or environment relative to the use of the equipment.

The telenostics system relies on real-time diagnostics which informs equipment or fleet operators what has in fact happened and the root cause of the problem. Moreover, an in-service maintenance plan is altered by predicting what will happen in the future as to, for instance, the remaining useful life of the equipment. This prediction of the future is referred to as prognostics.

In one case Bayesian theories are applied where one has a given set of inputs and an observed set of outputs. By having this information available one can troubleshoot back to a node in the equipment for which a fault is expected to arise. The application of Bayesian theory to diagnostics and prognostics is unique and is covered by co-pending U.S. patent application Ser. No. 12/548,683, filed Aug. 27, 2009, assigned to the assignee hereof and incorporated herein by reference. Here the existence of faults, the likely cause of the fault, predictions of future faults, and the causes of these predicted faults are discussed. In the telenostics system, rather than testing a component against engineering specifications, one tests the entire fielded system to ascertain fault cause and the potential for future faults.

The telenostics system uses both adaptive diagnostics and adaptive prognostics to analyze the system in terms of failure modes and then uses modeling and simulation to troubleshoot back to the node for which a fault is detected or is expected. Thus, the telenostics system utilizes model-based diagnostics, the first step of which is to develop a model-based diagnostics algorithm for detecting faults and the cause of the faults. Then by adaptive learning the algorithms that are used in the diagnostics are either proven or adjusted based on real-time data. Thereafter, due to the adaptive learning process for the diagnostics one obtains the ability to predict performance.

Thus, in the telenostics system one takes real-time data and through analysis turns it into information. The system then uses tools that come from reliability-centered maintenance programs to turn the information into knowledge. One then uses algorithms to host the point of performance knowledge in order to predict performance and thereby enable fleet managers to issue modified maintenance instructions, thus lowering the total cost of operations, maintenance and labor.

Put another way, the basic components required for solving the problem include the following:

Diagnostics (historical): “What happened & what's the impact?”

The recognition and/or analysis of a problem or condition by its outward signs and symptoms.

Telematics (real-time): “What is happening & where is it happening?”

Sending, receiving and storing information via telecommunication devices, with the information including tracking location, remote diagnostics and identification of a problem.

Prognostics (future): “What will happen & when will it happen?”

Predicting the future condition of a component and/or system based on the analysis of failure modes, and correlation of these with an aging profile model.

Telenostics involves near real time sending, receiving and storing information from vehicles to off-board decision support and analysis systems via telecommunication devices including tracking fleet vehicle locations, employment of remote diagnostics, identifying a mechanical or electronic problem and automatically making this information known to the vehicle service organization.

In summary, the telenostics system utilizes adaptive learning to take the static maintenance information that has been provided by the original equipment manufacturers and create a revised maintenance plan. The adaptive learning employs real-time data to train algorithms through adaptive learning, with the outputted information enabling the managers to constantly update and improve, the algorithms to provide a revised maintenance plan. The subject system enables algorithms to learn what the differences are in condition, location and use of the equipment, and to provide a maintenance plan that is not static. As a result, in one embodiment data is used to update diagnostic algorithms which are then fed into a prognostic algorithm that either reflects the result of the updated diagnostic algorithm along with improved root cause calculations; or the prognostics algorithm can itself be altered based on real-time in-service data.

In one embodiment, for prognostics one starts with a synthetic set of data. One then provides an algorithm which analyzes the data and then analyzes the changes in the real-time data. The changes in the real-time data are, for instance, used to predict life time, revise scheduling, or provide more accurate mean time to failure. Thus, one gathers real data and estimates the difference between the synthetic data and the real-time data and adjusts the algorithms.

In a preferred embodiment of the telenostics system, what is provided is a method for managing a vehicle or equipment fleet comprising the steps of obtaining real-time data about the location and operational status/condition of vehicles in the fleet; optimizing maintenance regimes using techniques to optimize maintenance tasks to the environment; performing predictive performance actions based on remaining useful life; and performing aggregation, analysis and information fusion to enable fleet managers and users to optimize fleet or equipment operation and support.

What this system does not show is a way of informing management as to the cost and availability of equipment or parts as it relates to mean time to failure and the costs associated with a buy or replace decision.

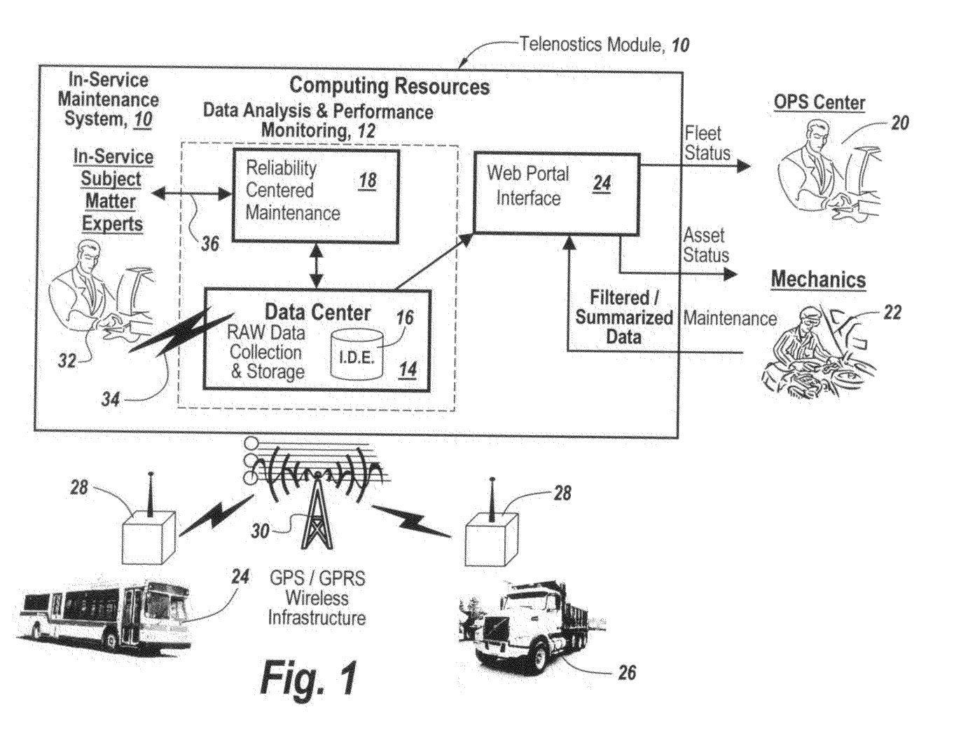

Prior to describing the performance logic system in detail and referring to FIG. 1, a telenostics in-service maintenance system corresponding to a telenostics module 10 involves computing resources that include a data analysis and performance monitoring module 12.

Included in the computing resources is a data center 14 which collects raw data and stores it in an integrated data environment 16 that incorporates the results of all stored data. Data center 14 then outputs the results of real-time diagnostics and prognostics to enable recommending changes to maintenance plans that are communicated to either an operation center 20 or to mechanics 22. In one embodiment, this is accomplished through the use of a web portal 24.

It is the purpose of the data analysis and performance monitoring module 12 to perform real-time mission monitoring performance optimization utilizing diagnostics and prognostics, with the diagnostics and prognostics being updated utilizing real-time data from for instance a bus 24 or truck 26. Real-time location-based usage monitoring, diagnostics, exceedances and sensor data is transmitted via a communications interface involving a transmitter 28 that uses terrestrially-based towers or satellites 30 to provide a wireless infrastructure from which data collected from the vehicles is transmitted to data analysis and performance monitoring module 12.

Thus, not only is real-time location tracked at module 12, also usage of the asset is tracked, as well as real-time diagnostics information having parameters which are transmitted over the wireless link and infrastructure along with sensor data. Any on-board diagnostics information is also transmitted wirelessly, as well as the fact of an exceedance of a performance standard.

As can be seen, in-service subject matter experts 32 are either wirelessly linked or hard wired to the data and analysis performing module 12 as illustrated respectively at 34 and 36. As a result reliability-centered maintenance can be provided by the in-service subject matter experts. Moreover, the results of the diagnostics and prognostics are transmitted back to the in-service subject matter experts.

It will be appreciated that sensor data is transmitted continuously to operation maintenance center 20, and to the integrated data environment 16.

Actionable information is automatically provided to the in-service subject matter experts through an in-service terminal and also to maintainers, such as mechanics 22. Note that in one embodiment performance monitoring and diagnostics are available on-vehicle, whereas in another embodiment the data analysis and performance module 12 performs the diagnostics and prognostics.

In summary, the telenostics system results in better asset utilization, global consistency for in-service maintenance, reduced service administration, reduced operating costs, management of equipment lifecycle costs, improved equipment reliability, extended equipment life and reduction in emergency repairs.

The telenostics system therefore facilitates data protocol interpretation, failure history interpretation and updates of design information to turn the real-time data into information for reliability-centered maintenance analysis to create an optimized in-service maintenance plan.

### The Performance Logic Module

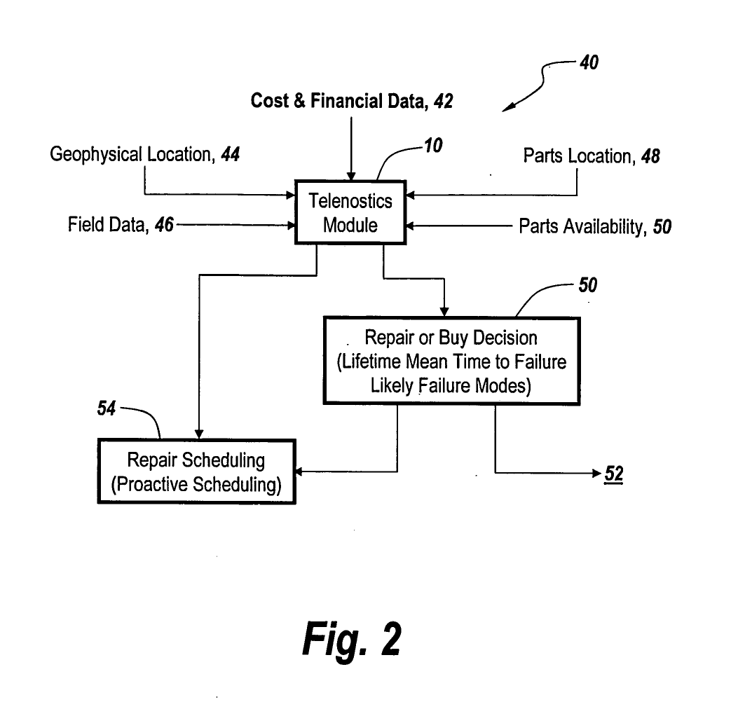

Referring now to FIG. 2, the performance logic module 40 includes cost and financial data 42 that is coupled to telenostics module 10 so that cost and financial data may be included in the telenostics modules outputs which are based on realtime data. The geophysical location of the particular vehicle is shown at 44, with field data 46 being input to telenostics module 10.

A database containing parts location 48 and parts availability 50 is input to telenostics module 10.

When a fault code or other fault indicator is indicated as either having occurred or is about to occur, telenostics module 10 calculates the cost of doing either repair or the cost of buying the failed part.

The repair or buy decision illustrated at 50 incorporates a lifetime, mean time to failure, and likely failure modes of a particular element.

If for instance in the diagnostics or prognostics performance of the telenostics module a particular element is identified as having a limited lifetime or a short mean time to failure for a given likely failure mode, then the cost of either buying the element outright or repairing it is compared at 50 so as to provide either a buy indicator 52 or to inform a repair scheduling module 54, which operates with proactive scheduling to provide information that will lead to an effective repair.

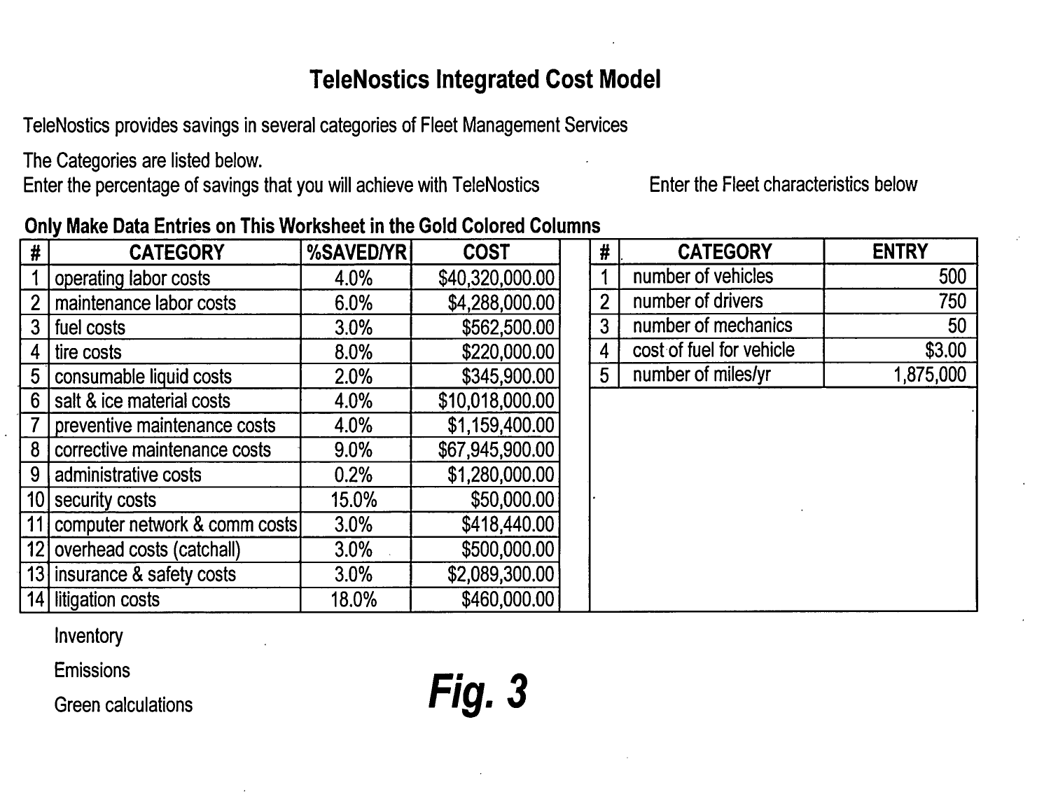

As mentioned hereinbefore, there are various costs associated with repair and these costs are illustrated in the chart of FIG. 3 to include for instance operating labor costs, maintenance labor costs, fuel costs, tire costs, consumable liquid costs, salt and ice material costs, preventive maintenance costs, corrective maintenance costs, administrative costs, security costs, computer network and communications, overhead costs, insurance and safety costs and litigation costs.

With the database of realtime cost data one can estimate the true cost of doing a repair if for instance it is ascertained that the part either has failed or is immediately about to fail.

If on the other hand it is determined that the useful lifetime of the part for instance extends beyond two weeks, then it may be appropriate to move the vehicle having the part to a convenient staging area at which point preventive maintenance can be performed.

Key to the decisions of repair or buy are the realtime on the ground inputs from the vehicle itself including its location and in general its condition. Note that the costs involved may be correlated to the particular location of the vehicle. Thus for instance if the vehicle is in an inaccessible or remote location, the cost of repairing the vehicle or the parts thereof in this remote location may turn out to be excessively high.

Up to the present time there has been no analysis of the cost of a particular repair, but rather only the diagnosis of a particular fault or the prognosis that a particular fault will occur, rather than taking into account the true fleet management costs of both scenarios.

It is thus a feature of the subject invention to be able to automatically account for a wide range of costs having to do with either repair or buying a part which takes into account not only the availability of the parts, but also the cost of transport of the parts to a repair facility or vehicle as well as the cost involved in down time for the repair of the vehicle as opposed to allowing the vehicle to run if it is projected that the fault will not occur immediately.

In operation, it will be appreciated that the performance logic module is part of an integrated data collection system. The performance logic module pulls in maintenance records and the cost of maintenance including how much time, labor and materials is involved for a maintenance technician. It can thus be seen that the cost of maintenance is incorporated into the telenostics system.

In one embodiment the data input is for instance how much was spent to address a particular fault code or failure. This includes both labor and material cost.

Complimenting this information is not only the static cost of the repair or replace scenario, but also the cost of whether it is more cost effective to buy a new part as opposed to repairing an old part.

The decision making process of how much useful life is left in a particular item that needs to be repaired is also calculated and presented to a fleet manager so that the decision for the fleet manager is augmented by the cost involved. Also output is where the item that needs to be repaired is in its lifecycle and how much useful life is predicted to be left. The result is that the performance logic module pulls realtime costs of what is happening in the fleet.

It is noted that the costs are associated with the present state of the equipment and also for a given fault code the projected cost if this item or part were to fail, given a predictable lifecycle.

Thus, the telenostic system as augmented by the performance logic module provides fleet managers timely accurate predictive information to manage their fleet operations in a realtime environment on their own terms and to their own schedule. It is quite different than working from a static manufacturer's maintenance schedule.

In one embodiment, the subject system extracts realtime information off of the vehicle through data collection equipment realtime information which may in one embodiment be available on the vehicle's CAN bus. This information is sent to a dynamic data center where the information is fed into the performance logic module. Thus, what is presented to the performance logic module is realtime data including the location of the vehicle and its operating condition such as for instance engine temperature, oil pressure, and other operating device parameters. Moreover, for instance a driver's performance may be monitored, as by monitoring hard acceleration and heavy braking. All of these factors are brought into the performance logic module algorithm that is continually learning and getting better with the expansion of its database.

Note that fault codes are tied to specific performance characteristics of a specific element within the system. These elements for instance could be when it is expected that the element break, with an alternator or battery being an example.

Thus, the system isolates down the performance of the system to the element of that system, with the information relating to the element being accumulated in a dynamic data center which is the heart of the telenostics system.

The performance logic algorithm executes its instructions to be able to then prioritize information relating to the cost structure of repair versus replace in realtime against historical maintenance and repair information so that one can adapt and pull in faults that have occurred for the particular item. This can then tell the fleet manager the fault code and a recommendation for instance, to either stop immediately and effectuate a repair or whether one has for instance a number of weeks before one must do a repair.

The subject system thus enables the fleet manager to marshal the resources necessary as to, for instance, the best possible place for the repair, where the vehicle is located and the mission that it is on at a given moment. Given authorization, the purpose is to have the right part with the right maintenance technician available and a specific place and time to schedule the repair.

Thus, the fleet manager is able to optimize maintaining the performance of the fleet, taking vehicles out of service at a point in time of their choosing and protecting whatever assets that exist at the particular time.

Note that both static and dynamic information is involved in which static information is accumulated as to the actual cost of a particular element, with the historical information being resident in the subject system. The repair cost includes the historical repair costs, also resident in the subject system. The repair costs include how much time it takes to make the particular repair, which is equated to an hourly rate for a maintenance technician. Moreover, historical down time has a cost in terms of lost productivity and these costs are also inputted into the subject module.

Also there is a projected cost avoidance characteristic which refers to cost history associated with a decision that is made as to when to take the vehicle out of service, when to make the repair and how one can avoid more reactive costs, thus to provide a proactive decision by the fleet manger.

In short what is accomplished by the performance logic module is to make the proactive decisions of a fleet manager based on cost, amongst other factors.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A dynamic system for managing a vehicle fleet using operational and maintenance data, the vehicle fleet comprising one or more vehicles, the system comprising:
a data center receiving real-time data corresponding to at least the vehicle fleet; and
a reliability centered maintenance module coupled to the data center, the reliability centered maintenance module being executed by a processor;
the processor configured to:
execute a model-based adaptive diagnostics, wherein the model-based adaptive comprises one or more model-based diagnostics algorithms for detecting one or more faults and one or more causes of the one or more faults, wherein at least one of the one or more model-based diagnostics algorithms is updated based on the real-time data through adaptive learning;
execute a model-based adaptive prognostics, the model-based adaptive prognostics comprising one or more model-based prognostics algorithms for predicting one or more expected faults and one or more refined causes of the one or more expected faults, wherein at least one of the model-based prognostics algorithms is updated based on the real-time data through adaptive learning or through an input from the at least one of one or more updated model-based diagnostics algorithms; and
execute a financial module for calculating one or more computation parameters based on the one or more expected faults and the one or more refined causes, the computational parameters comprises at least one of cost of doing a repair of one or more parts, cost of buying of the one or more parts, cost of transport of the one or more parts to a repair facility and downtime costs;
characterized in that the processor facilitates adjustment of an original vehicle fleet maintenance plan for generating a revised vehicle fleet maintenance plan based on at least the model-based adaptive diagnostics, the model-based adaptive prognostics, and the one or more computational parameters.

2. (canceled)

3. The system of claim 1, wherein the financial module comprises a performance logic module that uses as inputs operating labor costs, maintenance labor costs, fuel costs, tire costs, consumable liquid costs, preventive maintenance costs, corrective maintenance costs, administrative costs, security costs, network and communication costs, insurance costs, safety costs, and litigation costs.

4. The system of claim 3, wherein the performance logic module is presented with the real-time data relating to a location of the one or more vehicles, historical down time cost, including cost associated with lost productivity, and operating condition of the one or more vehicles.

5. The system of claim 3, wherein the performance logic module prioritizes information relating to the cost of doing the repair versus cost of buying of the one or more parts in real-time.

6. The system of claim 3, wherein the performance logic module is provided with historical maintenance and repair information including faults that have occurred or are about to occur for the one or more parts.

7. The system of claim 3, wherein the performance logic module provides a recommendation to either immediately effectuate a repair or to wait to make the repair of the one or more parts.

8. The system of claim 3, wherein the performance logic module provides information that enables a fleet manager to marshal one or more resources necessary as to the best place for a repair, where the one or more vehicles are located, whereby a repair authorization from the fleet manager enables the fleet manager to have a right technician available at a specific place and time, thus to permit scheduling of the repair.

9. The system of claim 1, wherein the processor takes into account static and dynamic information of the one or mere vehicles of the vehicle fleet.

10. The system of claim 9, wherein the static information is accumulated as to the historical cost of one or more parts.

11. The system of claim 9, wherein the static information includes historical repair costs.

12. The system of claim 11, wherein the repair costs includes how much time it takes for a particular repair.

13. The system of claim 12, wherein the cost to make the particular repair is predicated on an hourly rate of a maintenance technician.

14. (canceled)

15. The system of claim 1, wherein the processor is configured to execute a module fore projecting cost avoidance including the cost history associated with a decision that is made as to when to take the one or more vehicles out of service or when to make a repair, also including costs which are to be avoided by making a prompt repair.
